(19) United States
(12) Patent Application Publication
(10) Pub. No.: US 2014/0294015 A1
(43) Pub. Date: Oct. 2, 2014

(54) RELAY DEVICE AND RELAY METHOD

(71) Applicant: FUJITSU LIMITED, Kawasaki-shi (JP)

(72) Inventors: Yutaka SEKINO, Toyohashi (JP); Chikahiro Deguchi, Toyohashi (JP); Naoki Maezawa, Toyohashi (JP); YOSHIKI OKUMURA, KOSAI (JP); Toshihiro Tomozaki, Sagamihara (JP); Hiroaki Watanabe, Hamamatsu (JP); Hideyuki NEGI, Hamamatsu (JP)

(21) Appl. No.: 14/300,359

(22) Filed: Jun. 10, 2014

Related U.S. Application Data
(63) Continuation of application No. PCT/JP2011/078829, filed on Dec. 13, 2011.

(51) Int. Cl. H04L 12/709; G06F 13/364

(52) U.S. Cl. CPC H04L 45/245; G06F 13/364
USPC 370/462

(57) ABSTRACT

A relay device receives packets from an information processing apparatus or a relay device. The relay device updates a value of priority data indicating an accumulated wait time for arbitration contained in each of the received packets according to an elapsed time. The relay device selects a packet to be transmitted according to a result of comparison of the values of the pieces of the priority data contained in the received packets. The relay device transmits the selected packet to another relay device.

### CROSS-REFERENCE TO RELATED APPLICATION

This application is a continuation of International Application No. PCT/JP2011/078829, filed on Dec. 13, 2011, the entire contents of which are incorporated herein by reference.

### FIELD

The embodiments discussed herein are related to a relay device and a relay method.

### BACKGROUND

Conventionally, there is a known technology for a relay device that, upon receiving multiple pieces of data, determines the order of priority for transmitting the pieces of the data and transfers the pieces of the data in descending order of priority. As an example of such a relay device, there is a known relay device that, upon receiving multiple pieces of data transmitted via the same port, selects each of the pieces of the data by a round-robin method and transmits the pieces of the data to a relay device in the selected order.

An example of a network including multiple relay devices as described above will be explained below. FIG. 9 is a diagram for explaining a network in which multiple relay devices relay data. For example, the network illustrated in FIG. 9 includes three relay devices #1 to #3 and five information processing apparatuses #1 to #5.

Incidentally, in the network illustrated in FIG. 9, the relay devices #1 to #3 are connected in sequence, and the information processing apparatus #1 and the information processing apparatus #2 are connected to the relay device #1. Furthermore, in the network illustrated in FIG. 9, the information processing apparatus #3 is connected to the relay device #2, and the information processing apparatus #4 and the information processing apparatus #5 are connected to the relay device #3.

Next, an arbitration process performed by a relay device will be explained. FIG. 10 is a diagram for explaining an example of the relay device. In the example illustrated in FIG. 10, the relay device #2 includes a port input unit 30, a port input unit 31, a priority determining unit 32, and a port output unit 33. The port input unit 30 is an input unit of a port #1 connected to the information processing apparatus #3, and receives data from the information processing apparatus #3. Furthermore, the port input unit 31 is an input unit of a port #2 connected to the relay device #3, and receives data from the relay device #3.

The priority determining unit 32 selects, when each of the port input unit 30 and the port input unit 31 receives a piece of data to be transmitted to the relay device #1, the port #1 or the port #2 by the round-robin method, and outputs the piece of the data received by the input unit of the selected port to the port output unit. Furthermore, the port output unit 33 is an output unit of a port #0 connected to the relay device #1, and transmits data acquired from the priority determining unit 32 to the relay device #1.

In the network as described above, upon receiving pieces of data to be transmitted via the same port, each of the relay devices #1 to #3 independently performs a process to select a piece of data to be transmitted by the round-robin method and to transmit the pieces of the data in the selected order. For example, the relay device #3 receives, from the information processing apparatus #4 and the information processing apparatus #5, pieces of data to be transmitted to the information processing apparatus #1. In this case, the relay device #3 performs arbitration of the received pieces of the data because the relay device #3 transmits the pieces of the data by using the same port, and transmits a piece of data that won the arbitration to the relay device #2.

Similarly, upon receiving, from the information processing apparatus #3 and the relay device #3, pieces of data to be transmitted to the information processing apparatus #1, the relay device #2 performs arbitration of the received pieces of the data and transmits a piece of data that won the arbitration to the relay device #1. Similarly, upon receiving, from the information processing apparatus #2 and the relay device #2, pieces of data to be transmitted to the information processing apparatus #1, the relay device #1 performs arbitration of the received pieces of the data and transmits a piece of data that won the arbitration to the information processing apparatus #1.

Furthermore, each of the information processing apparatuses #1 to #5 may perform communication to exchange pieces of data bidirectionally. For example, FIG. 11 is a diagram for explaining transmission and reception of pieces of data between the information processing apparatuses. Specifically, in the example illustrated in FIG. 11, the information processing apparatus #5 transmits data to the information processing apparatus #1 and the information processing apparatus #1 transmits a response to the information processing apparatus #5.

For example, the information processing apparatus #5 transmits transfer data to the information processing apparatus #1. Accordingly, the data is transferred to the information processing apparatus #1 via the three relay devices #1 to #3. Upon receiving the data, the information processing apparatus #1 transmits a response to the information processing apparatus #5. Accordingly, the response that has been transmitted by the information processing apparatus #1 is transferred to the information processing apparatus #5 via the three relay devices #1 to #3.
Patent Literature 1: Japanese Laid-open Patent Publication No. 07-219891
Patent Literature 2: Japanese Laid-open Patent Publication No. 2002-055944

However, in the technology for performing arbitration of pieces of data by the round-robin method as described above, each of the relay devices independently determines the order of transmission of the pieces of the data. Therefore, communication times between the information processing apparatuses vary depending on the number of the relay devices that relay the communications between the information processing apparatuses. As a result, the communication times between the information processing apparatuses become non-uniform.

For example, the information processing apparatus #2 transmits data to the information processing apparatus #1 via the single relay device #1, and therefore, a wait for arbitration occurs once. In contrast, the information processing apparatus #5 transmits data to the information processing apparatus #1 via the three relay devices #1 to #3, and therefore, a wait for arbitration occurs three times. Therefore, a time needed to transmit and receive data and a response is not the same between the communication by the information processing apparatus #1 and the information processing apparatus #2 and the communication by the information processing apparatus #1 and the information processing apparatus #5.

### SUMMARY

According to an aspect of an embodiment, a relay device includes a plurality of receiving units each being configured to receive a piece of data containing a value indicating the accumulated wait time for arbitration, an updating unit that updates the value indicating the accumulated wait time for arbitration contained in each of pieces of the data received by the receiving units, according to an elapsed time, a selecting unit that selects a piece of data to be transmitted, according to a result of comparison of the values indicating the accumulated wait times for arbitration contained in the respective pieces of the data, and a transmitting unit that transmits the piece of the data selected by the selecting unit to other device.

According to another aspect of an embodiment, a relay method implemented by a relay device that includes a plurality of receiving devices configured to receive pieces of data, and that relays the pieces of the data received by the receiving devices, the relay method including updating a value indicating an accumulated wait time for arbitration contained in each of the pieces of the data received by the receiving devices, selecting a piece of data to be transmitted, according to a result of comparison of the values indicating the accumulated wait times for arbitration contained in the respective pieces of the data, and transmitting the piece of the data selected at the selecting to other device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining a communication system according to a first embodiment;

FIG. 2A is a diagram for explaining an example of a packet transmitted by an information processing apparatus according to the first embodiment;

FIG. 2B is a diagram for explaining an example of a header;

FIG. 2C is a diagram for explaining an example of a payload;

FIG. 3 is a diagram for explaining a functional configuration of a relay device according to the first embodiment;

FIG. 4 is a diagram for explaining an example of a process for updating priority data;

FIG. 5 is a diagram for explaining an example of a process for transmitting a packet;

FIG. 6 is a diagram for explaining an example of times taken for communications;

FIG. 7 is a flowchart for explaining an example of the flow of a process performed by the relay device according to the first embodiment;

FIG. 8 is a flowchart for explaining the flow of a process that the information processing apparatus and the relay device according to the first embodiment perform upon receiving a packet;

FIG. 9 is a diagram for explaining a network in which multiple relay devices relay data;

FIG. 10 is a diagram for explaining an example of the relay device; and

FIG. 11 is a diagram for explaining transmission and reception of pieces of data between information processing apparatuses.

### DESCRIPTION OF EMBODIMENTS

Preferred embodiments of the present invention will be explained with reference to accompanying drawings.

### [a] First Embodiment

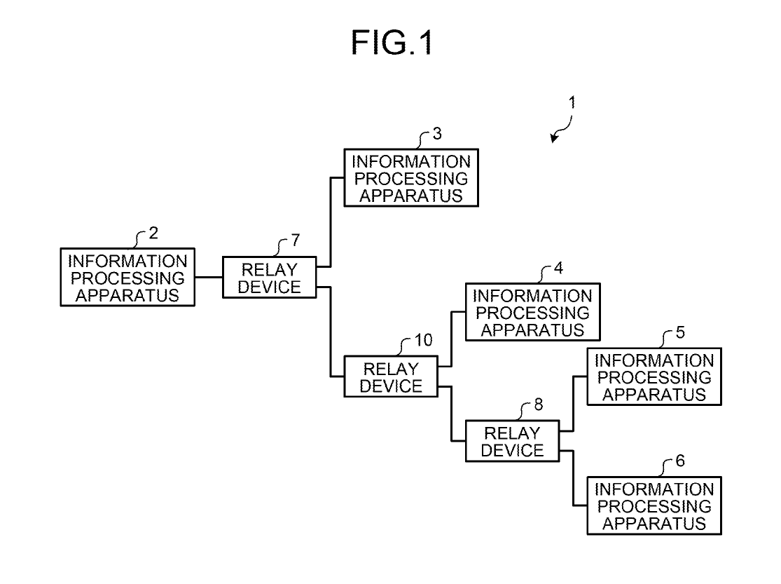

In a first embodiment described below, an example of a communication system including relay devices will be explained with reference to FIG. 1. FIG. 1 is a diagram for explaining the communication system according to the first embodiment. In the example illustrated in FIG. 1, a communication system 1 includes multiple information processing apparatuses 2 to 6 and multiple relay devices 7, 8, and 10.

Furthermore, in the example illustrated in FIG. 1, the relay device 7 is connected to the relay device 10, and the relay device 10 is connected to the relay device 8. Moreover, the information processing apparatuses 2 and 3 are connected to the relay device 7, the information processing apparatus 4 is connected to the relay device 10, and the information processing apparatuses 5 and 6 are connected to the relay device 8.

In the communication system 1 as described above, each of the information processing apparatuses 2 to 6 transmits and receives data via the relay devices 7, 8, and 10. Specifically, the information processing apparatus 2 and the information processing apparatus 3 transmit and receive data to and from each other via the relay device 7, and the information processing apparatus 2 and the information processing apparatus 4 transmit and receive data to and from each other via the relay devices 7 and 10. Furthermore, the information processing apparatus 2 and the information processing apparatus 5, or the information processing apparatus 2 and the information processing apparatus 6 transmit and receive data to and from each other via the relay devices 7, 8, and 10.

Incidentally, in the explanation below, each of the information processing apparatuses 2 to 6 transmit and receive a packet containing data. Furthermore, in the explanation below, an example will be described in which each of the information processing apparatuses 3 to 6 transmits a packet to the information processing apparatus 2, that is, each of the information processing apparatuses 3 to 6 and the information processing apparatus 2 transmit and receive data to and from each other. Moreover, in the explanation below, the relay devices 7 and 8 implement the same functions as those of the relay device 10, and explanation thereof will be omitted.

When each of the information processing apparatuses 2 to 6 transmits data to another information processing apparatus, it generates a packet that contains an Internet protocol (IP) address of an information processing apparatus serving as a transmission destination and contains transmission target data and priority data indicating the order of priority of the transmission target data. Then, each of the information processing apparatuses 2 to 6 transmits the generated packet to a relay device connected thereto.

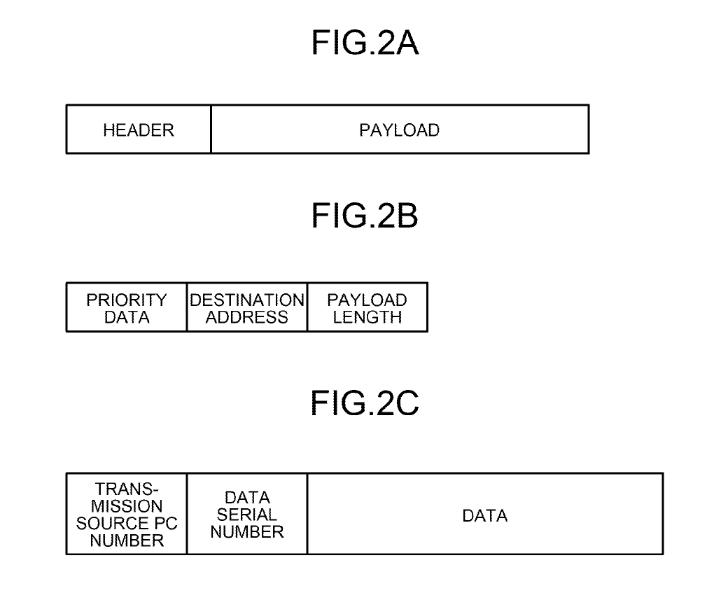

An example of the packet transmitted by each of the information processing apparatuses 2 to 6 will be explained below with reference to FIGS. 2A to 2C. FIG. 2A is a diagram for explaining an example of the packet transmitted by the information processing apparatus according to the first embodiment. FIG. 2B is a diagram for explaining an example of a header. FIG. 2C is a diagram for explaining an example of a payload.

As illustrated in FIG. 2A, each of the information processing apparatuses 2 to 6 transmits a packet containing a header and a payload. In the header of the packet, as illustrated in FIG. 2B, priority data, a destination address, and a payload length are stored. The priority data is information indicating the order of priority for transmitting the packet.

For example, each of the information processing apparatuses 2 to 6 stores, as the priority data, a pre-set arbitrary value in the packet. Furthermore, as will be described later, each of the relay devices 7, 8, and 10 decrements the priority data by one at predetermined time intervals. Therefore, the priority data indicates an accumulated wait time taken for the packet to wait for arbitration in the relay devices 7, 8, and 10.

Moreover, as will be described later, each of the relay devices 7, 8, and 10 determines that timeout has occurred when the priority data becomes “0”. Therefore, each of the information processing apparatuses 2 to 6 stores, as the priority data, a time taken until timeout occurs.

Furthermore, the destination address is an IP address of an information processing apparatus serving as a destination of the packet. The payload length is information indicating the capacity of the payload of the packet. Moreover, as illustrated in FIG. 2C, in the payload of the packet, a transmission source personal computer (PC) number of an information processing apparatus serving as a transmission source, a data serial number, and data are stored. The transmission source PC number is a number for uniquely identifying the information processing apparatus that has generated the packet, and the data serial number is information indicating the order of the data stored in the packet.

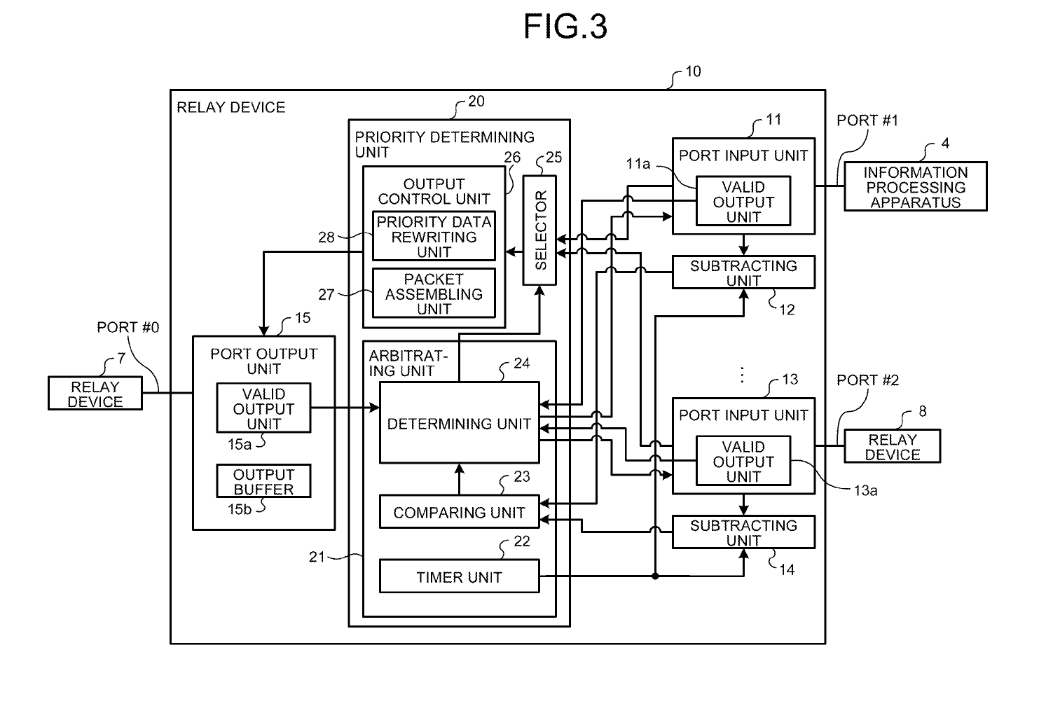

Next, an example of the relay device 10 will be explained with reference to FIG. 3. FIG. 3 is a diagram for explaining a functional configuration of the relay device according to the first embodiment. Specifically, FIG. 3 illustrates functions of input ports of ports #1 and #2 and an output port of a port #0 among the multiple ports #0 to #2 included in the relay device 10. Namely, the relay device 10 has the same functional configuration as illustrated in FIG. 3 for each of the ports #0 to #2 with respect to each of the ports #0 to #2 serving as an output destination.

For example, in the example illustrated in FIG. 3, the relay device 10 includes a port input unit 11, a subtracting unit 12, a port input unit 13, a subtracting unit 14, a port output unit 15, and a priority determining unit 20. Incidentally, the port input unit 11 is an input unit of the port #1 connected to the information processing apparatus 4, and the port input unit 13 is an input unit of the port #2 connected to the relay device 8. Furthermore, the port output unit 15 is an output unit of the port #0 connected to the relay device 7.

Moreover, the subtracting unit 12 is associated with the port #1, and the subtracting unit 14 is associated with the port #2. Furthermore, in the example illustrated in FIG. 3, the port input unit 11 includes a valid output unit 11a. Similarly, the port input unit 13 includes a valid output unit 13a. The port output unit 15 includes a valid output unit 15a and an output buffer 15b. Moreover, the priority determining unit 20 includes an arbitrating unit 21, an output control unit 26, and a selector 25. Furthermore, the arbitrating unit 21 includes a timer unit 22, a comparing unit 23, and a determining unit 24. Furthermore, the output control unit 26 includes a priority data rewriting unit 28 and a packet assembling unit 27. Incidentally, while omitted in FIG. 3, the relay device 10 includes multiple ports in addition to the ports #0 to #2, and includes input units and subtracting units associated with the input units for the respective ports.

A process performed by the relay device 10 will be explained below. Incidentally, the port input unit 13 performs the same process as the port input unit 11, and therefore, explanation thereof will be omitted. Furthermore, the subtracting unit 14 performs the same process as the subtracting unit 12, and therefore, explanation thereof will be omitted.

The port input unit 11 is the input unit of the port #1 connected to the information processing apparatus 4, and receives a packet transmitted by the information processing apparatus 4. Furthermore, when receiving the packet, the port input unit 11 holds the received packet and sets, in the valid output unit 11a, a valid bit to “on” indicating that the packet is held.

Moreover, the port input unit 11 acquires a value of the priority data of the packet, and outputs the acquired value of the priority data to the subtracting unit 12. Furthermore, when receiving an acknowledge from the determining unit 24, the port input unit 11 outputs the packet being held to the selector 25 of the priority determining unit 20. Moreover, when outputting the packet, the port input unit 11 clears the valid bit set in the valid output unit 11a and clears the value held by the subtracting unit 12.

When the port input unit 11 sets the valid bit, the valid output unit 11a outputs a signal indicating reception of the packet to the determining unit 24. Specifically, the valid output unit 11a outputs a signal indicating “on” to the determining unit 24 when the valid bit is set to “on”, and outputs a signal indicating “off” when the valid bit is cleared.

The subtracting unit 12 updates the priority data of the packet received via the port #1 at predetermined time intervals. Specifically, the subtracting unit 12 acquires, from the port input unit 11, the priority data of the packet received via the port #1. In this case, the subtracting unit 12 holds the value of the acquired priority data and outputs the held value of the data to the comparing unit 23 and the selector 25. Furthermore, when receiving a signal indicating execution of update from the timer unit 22, the subtracting unit 12 increments the held value by one. Then, the subtracting unit 12 outputs the new value to the comparing unit 23.

Incidentally, in the example illustrated in FIG. 3, a line indicating the connection between the subtracting unit 12 and the selector 25 is omitted to prevent the drawing from becoming complex.

The port output unit 15 is the output unit of the port #0 connected to the relay device 7, and when receiving a packet sent by the output control unit 26, stores the received packet in the output buffer 15b. Furthermore, when storing the packet, the port output unit 15 sets a valid bit in the valid output unit 15a.

Then, the port output unit 15 outputs the packet stored in the output buffer 15b to the relay device 7. Furthermore, when transmitting the packet to the relay device 7, the port output unit 15 clears the valid bit set in the valid output unit 15a.

Incidentally, similarly to the other valid output unit 11a, the valid output unit 15a outputs a signal indicating “on” to the determining unit 24 when the valid bit is set, and outputs a signal indicating “off” to the determining unit 24 when the valid bit is cleared.

Next, a process performed by the priority determining unit 20 will be explained below. When the multiple ports receive packets at the same time, the arbitrating unit 21 performs arbitration of the received packets. The timer unit 22 transmits a signal indicating execution of update to the subtracting units 12 and 14 at predetermined time intervals. Incidentally, the timer unit 22 transmits the signal indicating execution of update to all of the subtracting units associated with all of the ports included in the relay device 10 although they are not illustrated in FIG. 3.

The comparing unit 23 compares the pieces of the priority data contained in the packets received by the respective ports. Then, the comparing unit 23 outputs a result of comparison to the determining unit 24. Specifically, the comparing unit 23 acquires the pieces of the priority data from the subtracting units associated with the respective ports. Then, the comparing unit 23 compares the acquired pieces of the priority data, discriminates a piece of priority data having the smallest value, and determines a port that has received a packet containing the discriminated priority data.

Subsequently, the comparing unit 23 notifies the determining unit 24 of the determined port. Incidentally, if multiple pieces of priority data have the smallest values, the comparing unit 23 notifies the determining unit 24 of multiple ports that have received packets containing the pieces of the priority data having the smallest values.

The determining unit 24 acquires a signal indicating reception of the packet from each of the valid output units 11a and 13a of the input units of the ports. Furthermore, the determining unit 24 acquires, from the comparing unit 23, the result of the comparison of the pieces of the priority data contained in the packets received by the respective ports. Moreover, the determining unit 24 determines whether a signal from the valid output unit 15a of the port output unit 15 is “on” or “off”. Specifically, the determining unit 24 determines whether the port output unit 15 has transmitted the packet.

Then, when determining that the signal from the valid output unit 15a of the port output unit 15 is “off”, that is, when determining that the port output unit 15 has not transmitted the packet, the determining unit 24 performs a process as described below. Specifically, the determining unit 24 outputs an acknowledge to a receiving unit of the port that is notified, as the result of the comparison, by the comparing unit 23 among the ports that have output the signals indicating the reception of the packets. Furthermore, the determining unit 24 notifies the selector 25 of the port to which the acknowledge is output.

Furthermore, when notified of the multiple ports, the determining unit 24 performs a process as described below. Specifically, the determining unit 24 selects a single port by the round-robin method from among the ports, for which the valid bits are set to “on” and which are notified by the comparing unit 23. Then, the determining unit 24 outputs an acknowledge to a receiving unit of the selected port, and notifies the selector 25 of the selected port.

The selector 25 transfers, to the output control unit 26, the packet received by the port notified by the determining unit 24 among the ports included in the relay device 10. Furthermore, the selector 25 outputs, to the output control unit 26, a value output by the subtracting unit notified by the determining unit 24, that is, the value of the priority data. For example, when the selector 25 is notified of the port #1 by the determining unit 24, the selector 25 transfers, to the output control unit 26, the packet output by the port input unit 11, and transfers, to the output control unit 26, the priority data output by the subtracting unit 12 associated with the port #1.

When receiving the packet from the port input unit 11 or the port input unit 13 via the selector 25, the packet assembling unit 27 holds the received packet. Then, when the priority data rewriting unit 28 updates the priority data of the packet being held, the packet assembling unit 27 outputs the packet to the port output unit 15.

The priority data rewriting unit 28 acquires pieces of the priority data from the subtracting units 12, 14, and so on associated with all of the ports included in the relay device 10 via the selector. Specifically, the priority data rewriting unit 28 acquires pieces of the priority data, in each of which a wait time for an arbitration process that the relay device 10 has performed on the packet received by the packet assembling unit 27 is reflected. Then, the priority data rewriting unit 28 updates the pieces of the priority data of the packets held by the packet assembling unit 27 with the acquired values of the pieces of the priority data.

For example, the port input unit 11, the valid output unit 11a, the subtracting unit 12, the port input unit 13, the valid output unit 13a, the subtracting unit 14, the port output unit 15, the valid output unit 15a, and the output buffer 15b are electronic circuits. Furthermore, the priority determining unit 20, the arbitrating unit 21, the timer unit 22, the comparing unit 23, the determining unit 24, the selector 25, the output control unit 26, the packet assembling unit 27, and the priority data rewriting unit 28 are electronic circuits. Incidentally, examples of the electronic circuit include an integrated circuit such as an application specific integrated circuit (ASIC) or a field programmable gate array (FPGA) and include a central processing unit (CPU) and a micro processing unit (MPU).

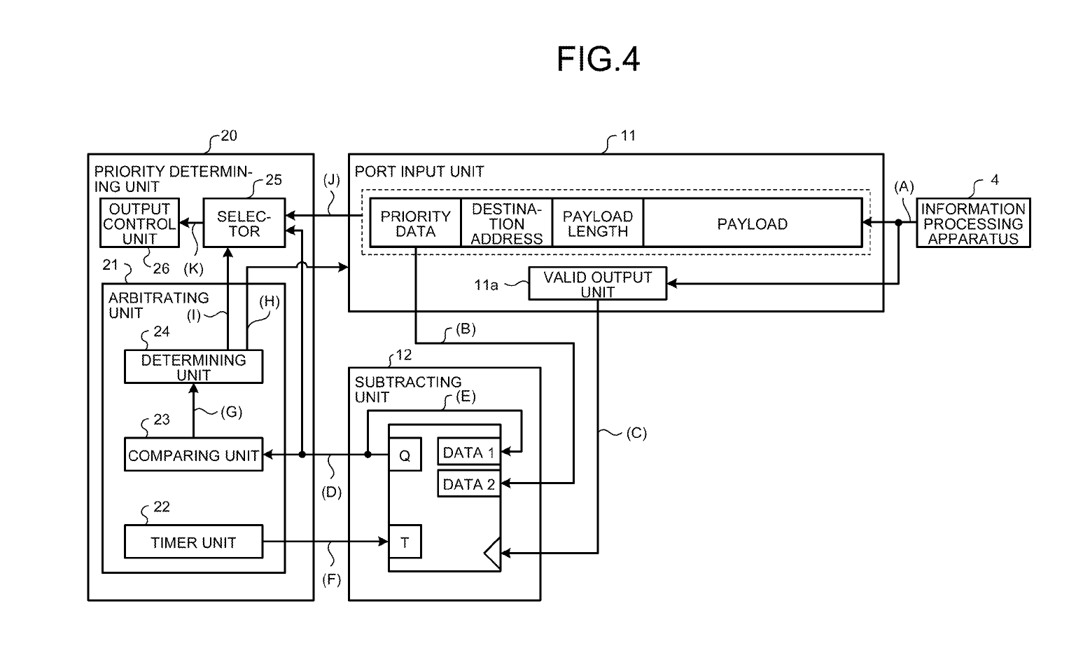

Next, a specific example of the process for updating the priority data of the packet by the relay device 10 will be explained with reference to FIG. 4. FIG. 4 is a diagram for explaining an example of the process for updating the priority data. In the explanation below, an example will be described in which the port #1 transmits a received packet.

For example, in the example illustrated in FIG. 4, the subtracting unit 12 includes a counter circuit having a Data 1 terminal and a Data2 terminal as data input terminals. When a signal from the valid output unit 11a is “off”, that is, when valid bit is not set in the valid output unit 11a, the counter circuit outputs, via a Q terminal, a value input via the Data 1 terminal.

Furthermore, when the signal from the valid output unit 11a is changed from “off” to “on”, the counter circuit outputs, via the Q terminal, a value input via the Data 2 terminal. Moreover, when a signal is input to a T terminal connected to the timer unit 22, the counter circuit decrements the input value by one and outputs the value via the Q terminal.

In the following, an example will be described in which the subtracting unit 14 includes the counter circuit as described above. For example, as indicated by (A) in FIG. 4, the port input unit 11 receives a packet from the information processing apparatus 4. Subsequently, as indicated by (B) in FIG. 4, the port input unit 11 outputs a value of the priority data to the Data 2 terminal of the counter circuit and sets a valid bit in the valid output unit 11a.

Then, as indicated by (C) in FIG. 4, the signal from the valid output unit 11a is changed form “off” to “on”, and the counter circuit of the subtracting unit 12 acquires an input from the Data 2 terminal, that is, the value of the priority data received by the port input unit 11. Subsequently, as indicated by (D) in FIG. 4, the counter circuit of the subtracting unit 12 outputs the acquired value to the comparing unit 23 and the selector 25. Furthermore, as indicated by (E) in FIG. 4, the counter circuit of the subtracting unit 12 also outputs the value to the Data 1 terminal. Namely, the counter circuit of the subtracting unit 12 holds the value of the priority data.

Incidentally, as indicated by (F) in FIG. 4, the counter circuit of the subtracting unit 12 receives a signal from the timer unit 22 at predetermined time intervals. Therefore, the counter circuit of the subtracting unit 12 outputs a value obtained by decrementing the held value by one at predetermined time intervals. At this time, the output from the Q terminal is also transferred to the Data 1 terminal, so that the counter circuit holds the decremented value. As described above, the subtracting unit 12 reflects, in the priority data, a wait time taken for the packet received by the port input unit 11 to wait for arbitration.

Furthermore, the comparing unit 23 compares the values of the pieces of the priority data acquired from the subtracting units 12 and 14 each being associated with a corresponding port, discriminates a port associated with the subtracting unit that has sent the smallest value, and notifies the determining unit 24 of the discriminated port as indicated by (G) in FIG. 4. For example, if the value notified by the subtracting unit 12 is “3” and the value notified by the subtracting unit 14 is “5”, the comparing unit 23 notifies the determining unit 24 of the port #1 associated with the subtracting unit 12.

When the signal from the valid output unit 15a is “off” and when the determining unit 24 acquires the notice of the port from the comparing unit 23, the determining unit 24 outputs an acknowledge to the port input unit 11 of the notified port #1 as indicated by (H) in FIG. 4. Furthermore, as indicated by (I) in FIG. 4, the determining unit 24 notifies the selector 25 of the port #1.

Subsequently, as indicated by (J) in FIG. 4, the port input unit 11 outputs the received packet to the selector 25. In this case, the selector 25 has already received the notice of the port #1 from the determining unit 24, the selector 25 outputs the packet output by the port input unit 11 to the output control unit 26 as indicated by (K) in FIG. 4. Furthermore, the selector 25 outputs, to the output control unit 26, the value output by the subtracting unit 12 associated with the port #1, that is, the priority data in which the wait time for the arbitration in the relay device 10 is reflected.

Incidentally, when the value of the priority data becomes “0” by decrement by the subtracting unit 12, when the value of the priority data becomes equal to or smaller than a predetermined threshold, or when the value of the priority data causes counter underflow, the relay device 10 performs a process as described below. Specifically, the relay device 10 transmits a signal or a packet indicating that the packet received by the port #1 associated with the subtracting unit 12 is timed out to the transmission source of the packet via the port #1. Incidentally, the process performed by the relay device 10 to transmit the signal or the packet indicating the timeout is the same as the process in the conventional technology, and therefore, detailed explanation thereof will be omitted.

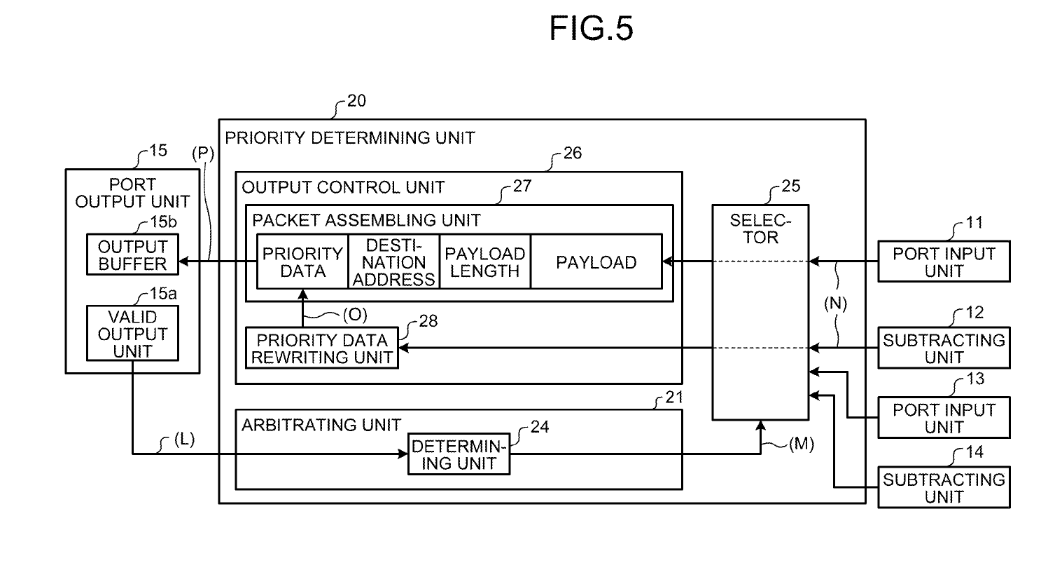

Next, a specific example of the process for transmitting a packet containing new priority data will be explained with reference to FIG. 5. FIG. 5 is a diagram for explaining an example of the process for transmitting the packet. For example, when the signal from the valid output unit 15a becomes “off” as indicated by (L) in FIG. 5, the determining unit 24 notifies the selector 25 of the port #1 as indicated by (M) in FIG. 5.

In this case, as indicated by (N) in FIG. 5, the selector 25 transfers the packet output by the port input unit 11 of the port #1 to the packet assembling unit 27 of the output control unit 26. Furthermore, the selector 25 transfers, to the priority data rewriting unit 28, the output from the subtracting unit 12 associated with the port #1, that is, the priority data in which the wait time taken for the packet to wait for arbitration in the relay device 10 is reflected.

In this case, as indicated by (O) in FIG. 5, the priority data rewriting unit 28 rewrites the priority data in the packet held by the packet assembling unit 27 with the priority data acquired from the subtracting unit 12. Subsequently, as indicated by (P) in FIG. 5, the packet assembling unit 27 outputs the packet to the output buffer 15b of the port output unit 15.

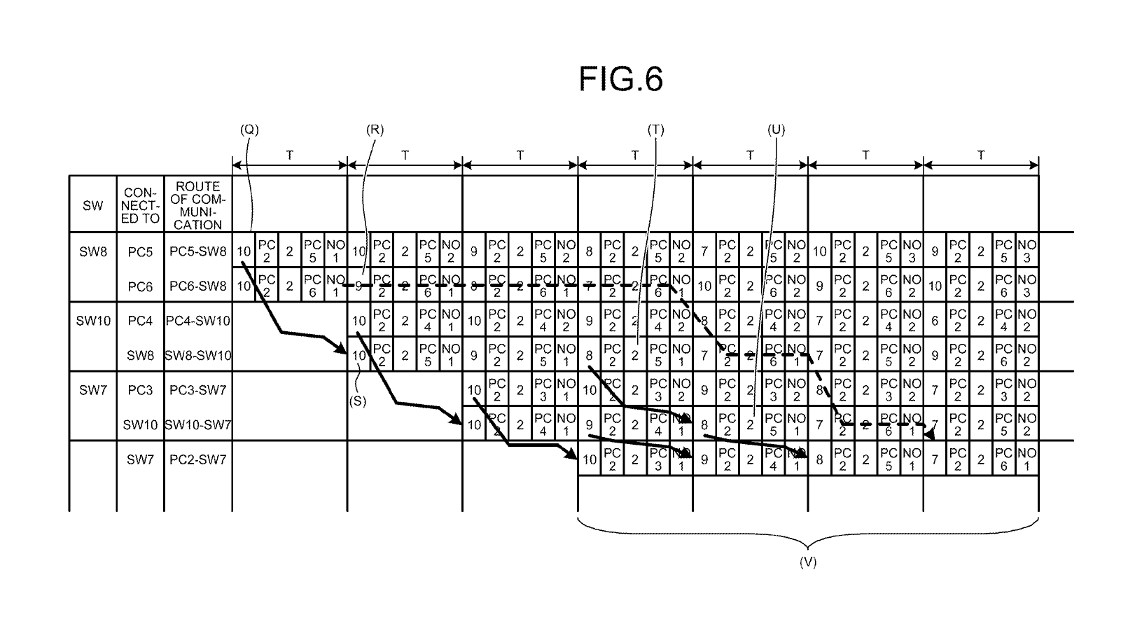

Next, an example of a time taken for a communication by each of the information processing apparatuses 2 to 6 will be described with reference to FIG. 6. Incidentally, in FIG. 6, an example is described in which each of the information processing apparatuses 3 to 6 continuously transmits packets to the information processing apparatus 2 serving as a destination.

FIG. 6 is a diagram for explaining an example of times taken for communications. Incidentally, in the example illustrated in FIG. 6, the information processing apparatuses 2 to 6 are described as PCs 2 to 6 and the relay devices 7, 8, and 10 are described as switches (SWs) 7, 8, and 10, respectively. Furthermore, in the example illustrated in FIG. 6, a timing at which each of the relay devices 7, 8, and 10 executes a process is illustrated in the horizontal direction, and packets acquired by the relay devices 7, 8, and 10 are illustrated in the vertical direction.

Specifically, in the example illustrated in FIG. 6, packets that the relay device 8 receives from the information processing apparatuses 5 and 6 and packets that the relay device 10 receives from the information processing apparatus 4 and the relay device 8 are illustrated in this order from the top. Furthermore, packets that the relay device 7 receives from the information processing apparatus 3 and the relay device 10, and packets that the information processing apparatus 2 receives follow in this order.

Moreover, in the example illustrated in FIG. 6, priority data, a destination of the packet, a payload length, an information processing apparatus that has output the packet, and a serial number of the packet output by each of the information processing apparatuses are illustrated, all of which are contained in each of the packets. Incidentally, in the example illustrated in FIG. 6, it is assumed that each of the information processing apparatuses 3 to 6 transmits packets, each of which contains the priority data of “10” and the payload of “2”. Furthermore, each of the relay devices 7, 8, and 10 decrements the priority data by one at each timing.

For example, at the first timing, the relay device 8 receives packets from the information processing apparatuses 5 and 6. Subsequently, because all of the pieces of the priority data in the received packets are “10”, the relay device 8 selects the packet received from the information processing apparatus 5 by the round-robin method as indicated by (Q) in FIG. 6, and transmits the selected packet to the relay device 10 as indicated by an arrow in FIG. 6.

Furthermore, as indicated by (R) in FIG. 6, the relay device 8 decrements the priority data of the packet received from the information processing apparatus 6 by one, to thereby set the priority data to “9”. Moreover, at the second timing, because the port of the relay device 10 serving as the transmission destination of the packet is occupied, the relay device 8 waits without transmitting the packet.

Furthermore, as indicated by (S) in FIG. 6, the relay device 10 receives a packet transmitted by the relay device 8. Moreover, the relay device 10 receives a packet from the information processing apparatus 4. In this case, because the pieces of the priority data in the respective packets are the same, the relay device 10 selects the packet received from the information processing apparatus 4 by round-robin method, and transmits the selected packet to the relay device 7. Incidentally, at the third timing, because the port of the relay device 7 serving as the transmission destination is occupied and it is difficult to transmit a new packet, the relay device 10 waits in this state.

Furthermore, at the fourth timing, the port of the relay device 8 is released, so that the relay device 10 transmits a packet containing the smallest priority data to the relay device 7 as indicated by (T) in FIG. 6. Moreover, as indicated by (U) in FIG. 6, at the fifth timing, the relay device 7 transmits the packet containing the smallest priority data, that is, the packet received from the relay device 10 at the fourth timing, to the information processing apparatus 2.

Namely, in the example illustrated in FIG. 6, each of the relay devices 7, 8, and 10 transfers the packets as indicated by solid arrows in FIG. 6. Therefore, for example, each of the relay devices 7, 8, and 10 transfers the packet output by the information processing apparatus 6 as indicated by a dashed-line arrow in FIG. 6. Incidentally, as indicated by (V) in FIG. 6, the information processing apparatus 2 uniformly receives the packets transmitted by the information processing apparatuses 3 to 6.

Specifically, if each of the relay devices 7, 8, and 10 independently performs arbitration of packets by the round-robin method, the information processing apparatus 2 receives the packet output by the information processing apparatus 3 at a ratio of 1/2. Therefore, each of the relay devices 7, 8, and 10 is not able to equalize the communication times between the information processing apparatuses 2 to 6.

However, as illustrated in FIG. 6, each of the relay devices 7, 8, and 10 performs arbitration of packets to be transmitted, in accordance with the priority data indicating an accumulated wait time taken for each of the packets to wait for arbitration. Therefore, in the example illustrated in FIG. 6, each of the relay devices 7, 8, and 10 may equalize the times taken for communications between the information processing apparatuses 2 to 6.

A specific example for equalizing the times taken for communications between the information processing apparatuses 2 to 6 by the relay devices 7, 8, and 10 will be explained below. For example, assuming that a time taken for a packet to pass through each of the relay devices 7, 8, and 10 is denoted by T and the probability to win the packet arbitration in each of the relay devices 7, 8, and 10 is denoted by P, an average time taken for a communication between the information processing apparatuses 2 to 6 is represented by “Σ(1/P)×T”. Namely, a time taken for the communication between the information processing apparatuses 2 to 6 is a sum of “(1/P)×T” taken for a packet to pass through each of the relay devices 7, 8, and 10.

Furthermore, when each of the relay devices 7, 8, and 10 selects a packet to be transmitted by the round-robin method, the probability that each of the packets is selected by each of the relay devices 7, 8, and 10 is 1/2. Therefore, the average time taken for the communication between the information processing apparatus 2 and the information processing apparatus 3 becomes “(1/0.5)×T=2T”.

Moreover, the average time taken for the communication between the information processing apparatus 2 and the information processing apparatus 4 becomes “(1/0.5)×T+(1/0.5)×T=4T”. Furthermore, the average time taken for the communication between the information processing apparatus 2 and the information processing apparatuses 5 and 6 becomes “(1/0.5)×T+(1/0.5)×T+(1/0.5)×T=6T”.

In contrast, when each of the relay devices 7, 8, and 10 decrements the priority data of each of the packets at predetermined time intervals and transmits a packet containing the smallest priority data, the probability that each of the relay devices 7, 8, and 10 transmits the packet is obtained as follows.

Specifically, the relay device 8 transmits the packet output by the information processing apparatuses 5 and 6 with the probability of 1/2. Furthermore, the relay device 10 preferentially transmits a packet containing a longer accumulated wait time for arbitration; therefore, the relay device 10 transmits the packet output by the information processing apparatus 4 with the probability of 1/3 and transmits the packet output by the relay device 8 with the probability of 2/3. Moreover, the relay device 7 preferentially transmits a packet containing a longer accumulated wait time for arbitration; therefore, the relay device 7 transmits the packet output by the information processing apparatus 3 with the probability of 1/4 and transmits the packet output by the relay device 10 with the probability of 3/4.

Therefore, the average time taken for the communication between the information processing apparatus 2 and the information processing apparatus 3 becomes “(1/0.25)×T=4T”. Furthermore, the average time taken for the communication between the information processing apparatus 2 and the information processing apparatus 4 becomes “(1/0.33)×T+(1/0.75)×T=4.33T”. Moreover, the average time taken for the communication between the information processing apparatus 2 and the information processing apparatuses 5 and 6 becomes “(1/0.5)×T+(1/0.66)×T+(1/0.75)×T=4.83T”. As described above, each of the relay devices 7, 8, and 10 may approximately equalize the times taken for the communications between the information processing apparatuses 2 to 6.

Therefore, for example, even when a user of each of the information processing apparatuses 3 to 6 performs a packet communication with the information processing apparatus 2 by using a packet communication that is charged in proportion to a time taken for the communication, each of the relay devices 7, 8, and 10 may equalize the amounts of charges to the users of the respective information processing apparatuses 3 to 6. Furthermore, each of the relay devices 7, 8, and 10 preferentially transmits a packet containing a longer accumulated wait time for arbitration; therefore, it becomes possible to prevent timeout of the packets. Therefore, even when the communication system 1 becomes busy, it becomes possible to smoothly perform communications between information processing apparatuses located at a longer communication distance.

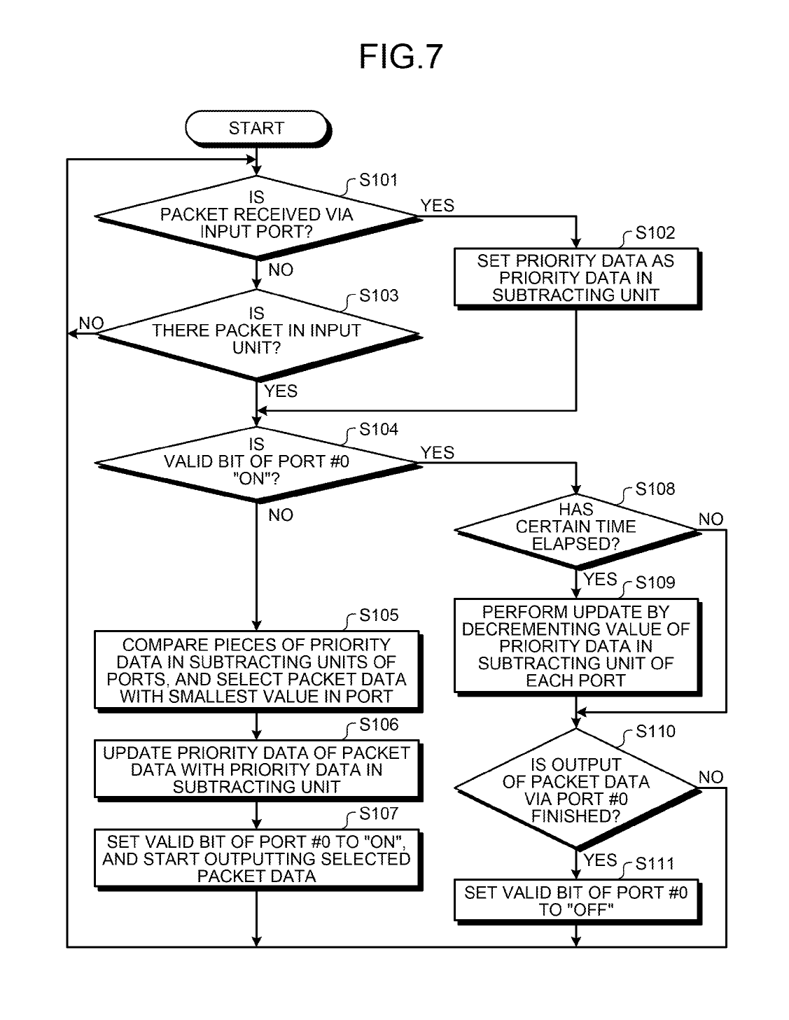

Next, the flow of a process performed by the relay device 10 will be explained with reference to FIG. 7. FIG. 7 is a flowchart for explaining an example of the flow of the process performed by the relay device according to the first embodiment. In the example in FIG. 7, the process performed by the relay device 10 when the relay device receives a packet output via the port #0 is illustrated.

For example, the relay device 10 determines whether the port input unit 11 or the port input unit 13 has received a new packet (Step S101). When determining that the packet has been received (YES at Step S101), the relay device 10 sets priority data of the received new packet in the subtracting units 12 and 14 (Step S102).

Subsequently, the relay device 10 determines whether a signal output by the valid output unit 15a of the port output unit 15 is “on” (Step S104). When determining that the signal output by the valid output unit 15a of the port output unit 15 is “off” (NO at Step S104), the relay device 10 performs a process as described below.

Specifically, the relay device 10 compares pieces of the priority data set in the subtracting units 12 and 14, and selects a piece of packet containing the priority data with the smallest value (Step S105). Subsequently, the relay device 10 updates the priority data of the selected packet with the priority data set in the subtracting units 12 and 14 (Step S106). Then, the relay device 10 sets “on” in the valid output unit 15a, and transmits the packet containing the updated priority data to the relay device 7 (Step S107).

In contrast, when determining that the signal from the valid output unit 15a is “on” (YES at Step S104), the relay device 10 determines whether a certain time has elapsed since the update of the priority data (Step S108). When determining that the certain time has elapsed since the update of the priority data (YES at Step S108), the relay device 10 decrements the values stored in the subtracting units 12 and 14 associated with the respective ports by one (Step S109). In contrast, when determining that the certain time has not elapsed since the update of the priority data (NO at Step S108), the relay device 10 skips the process at Step S109.

Subsequently, the relay device 10 determines whether output of a packet is finished (Step S110). When the output of the packet is finished (YES at Step S110), the relay device 10 sets the valid bit of the valid output unit 15a to “off” (Step S111). Then, the relay device 10 determines whether the port input unit 11 or the port input unit 13 has received a new packet again (Step S101). In contrast, when the output of the packet is not finished (NO at Step S110), the relay device 10 skips the process at Step S111, and determines whether the port input unit 11 or the port input unit 13 has received a new packet again (Step S101).

Furthermore, when determining that the port input unit 11 or the port input unit 13 has not received a new packet (NO at Step S101), the relay device 10 determines whether there is a packet in the port input unit 11 or the port input unit 13 (Step S103). Then, when there is a packet in the port input unit 11 or the port input unit 13 (YES at Step S103), the relay device 10 determines whether the signal output by the valid output unit 15a of the port output unit 15 is “on” (Step S104).

In contrast, when there is no packet in the port input unit 11 and the port input unit 13 (NO at Step S103), the relay device 10 determines whether the port input unit 11 or the port input unit 13 has received a new packet again (Step S101).

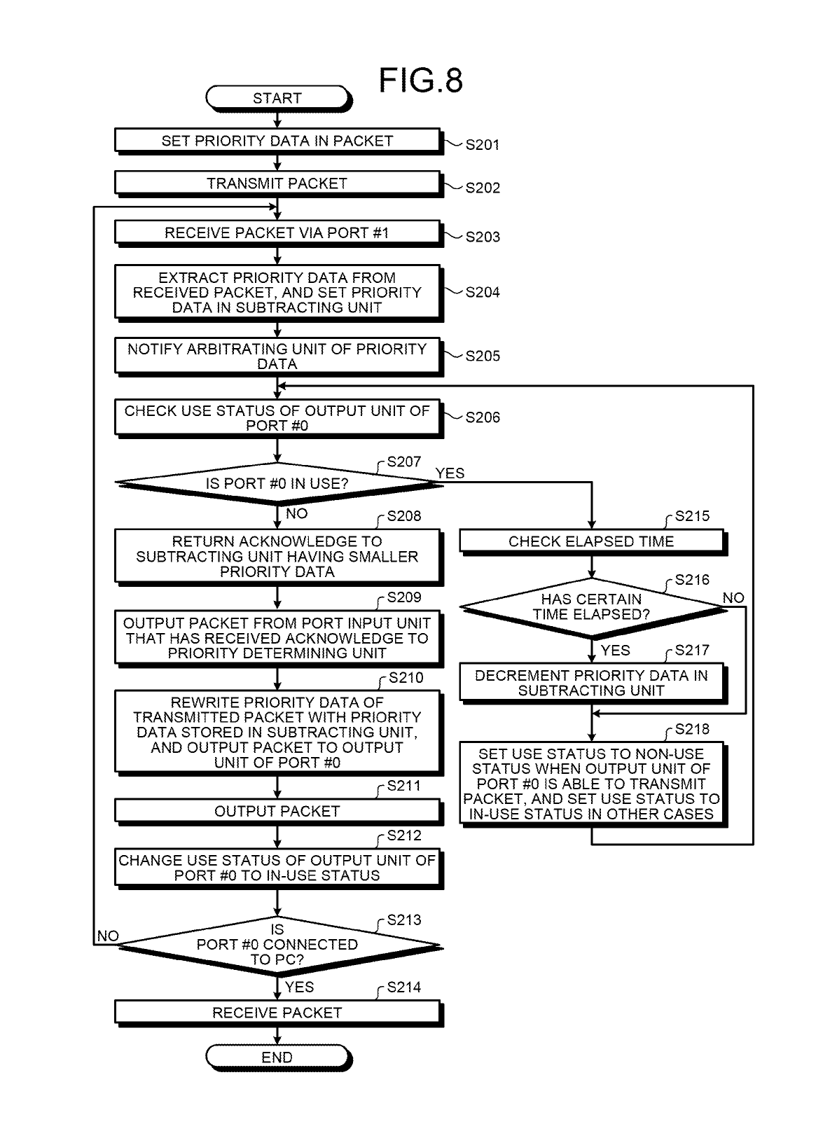

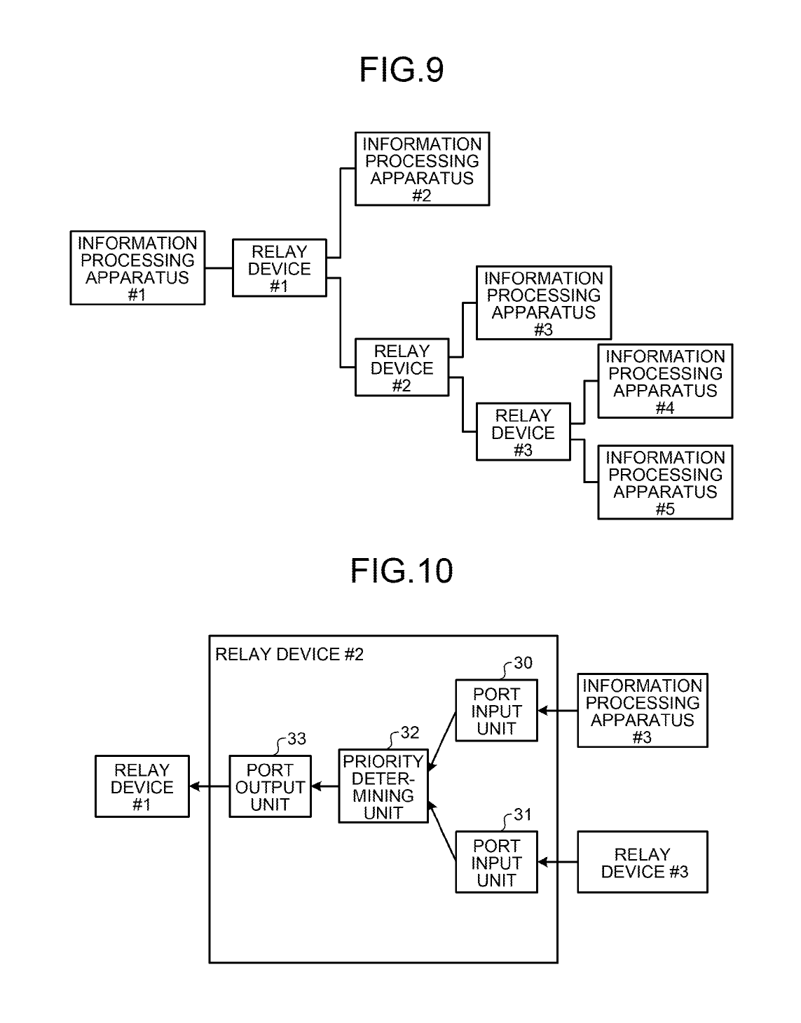

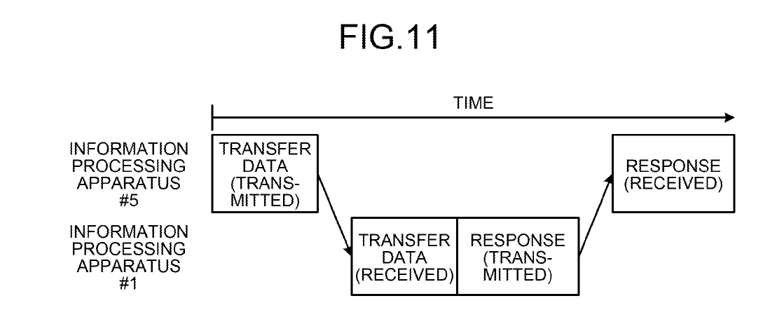

Next, the flow of a process performed by the relay device 10 when the relay device receives a packet from the information processing apparatus 4 will be explained with reference to FIG. 8. FIG. 8 is a flowchart for explaining the flow of a process performed by the information processing apparatus according to the first embodiment when the relay device receives a packet. For example, the information processing apparatus 4 sets priority data in a packet (Step S201), and transmits the packet to the relay device 10 (Step S202).

Accordingly, the relay device 10 receives the packet via the port #1 (Step S203). Subsequently, the relay device 10 extracts the priority data from the received packet, and sets the priority data in the subtracting unit 12 (Step S204). In this case, the subtracting unit 12 notifies the arbitrating unit 21 of the priority data (Step S205). Then, the arbitrating unit 21 checks a use status of the port output unit 15 (Step S206), and determines whether the port #0 is in use (Step S207).

When determining that the port #0 is not in use (NO at Step S207), the arbitrating unit 21 returns an acknowledge to one of the subtracting units 12 and 14 having smaller priority data (Step S208). Subsequently, the input unit of the port to which the acknowledge is returned outputs the packet to the priority determining unit 20 (Step S209).

In this case, the output control unit 26 of the priority determining unit 20 rewrites the priority data of the packet with the priority data stored in the subtracting unit, and outputs the packet containing the updated priority data to the port output unit 15 (Step S210). Subsequently, the port output unit 15 outputs the packet to the relay device 7 (Step S211). In this case, the port output unit 15 changes the use status to an in-use status (Step S212). Specifically, the port output unit 15 sets “on” in the valid output unit 15a.

Incidentally, when the transmission destination is the information processing apparatus (YES at Step S213), the information processing apparatus serving as the transmission destination receives the packet (Step S214), and the process is terminated. In contrast, when the transmission destination is the relay device (NO at Step S213), the relay device serving as the transmission destination performs the process at Step S203.

Incidentally, when the port #0 is in use (YES at Step S207), the relay device 10 checks an elapsed time (Step S215), and determines whether a certain time has elapsed since the update of the priority data (Step S216). When the certain time has elapsed (YES at Step S216), the relay device 10 decrements the priority data in each of the subtracting units 12 and 14 (Step S217).

In contrast, when the certain time has not elapsed (NO at Step S216), the relay device 10 skips the process at Step S217. Furthermore, the port output unit 15 sets the use status to a non-use status when it can transmit a new packet, and sets the use status to an in-use status in other cases (Step S218). Namely, the port output unit 15 sets “off” in the valid output unit 15a when it can transmit a packet, and sets “on” in the valid output unit 15a when it is not able to transmit a packet. Subsequently, the arbitrating unit 21 checks the use status of the port output unit 15 (Step S206).

Advantageous Effects of the Relay Device 10

As described above, the relay device 10 includes multiple ports for receiving packets each containing priority data indicating an accumulated wait time for arbitration. Furthermore, the relay device 10 updates the priority data contained in each of the received packets at predetermined time intervals. Then, the relay device 10 selects a packet to be transmitted in accordance with a result of comparison of the pieces of the priority data contained in the received packets, and transmits the selected packet.

Therefore, the relay device 10 may equalize times taken for communications between the information processing apparatuses 2 to 6. Furthermore, even when data transmission/reception and response transmission/reception are performed between the information processing apparatuses 2 to 6, the relay device 10 may equalize times taken for packets, each containing a response, to reach transmission destinations.

Furthermore, the relay device 10 decrements the priority data contained in each of the received packets at predetermined time intervals. Then, the relay device 10 selects a packet containing the smallest priority data from among the received packets as a packet to be transmitted. Therefore, the relay device 10 may easily determine a time taken until the packet to be transmitted is timed out.

Moreover, when there are multiple packets each containing the smallest priority data, that is, when the values of the pieces of the priority data are the same and the values are the smallest values, the relay device 10 performs a process as described below. Specifically, the relay device 10 selects a packet to be transmitted from among the packets each containing the smallest priority data by the round-robin method. Therefore, the relay device 10 may appropriately relay the packets without deadlock.

Furthermore, when the priority data of the packet becomes equal to or smaller than a predetermined threshold, the relay device 10 notifies the information processing apparatus serving as a transmission source of the packet of timeout. Therefore, the relay device 10 may promptly notify each of the information processing apparatuses 2 to 6 of the timeout.

### [b] Second Embodiment

While the embodiments of the present invention have been explained above, the present invention may be embodied in various forms other than the embodiments as described above. Therefore, other embodiments of the present invention will be explained below as a second embodiment.

(1) Update of the Priority Data

The relay device 10 as described above decrements the priority data in each of the packets at predetermined time intervals, and selects a packet containing the priority data with the smallest value as a packet to be transmitted; however, the embodiments are not limited thereto.

For example, the relay device 10 may increment the priority data in each of the packets at predetermined time intervals, and may transmit a packet containing the priority data with the greatest value. Furthermore, if such a process is to be performed, the relay device 10 discriminates a packet in which the value of the priority data has become greater than a predetermined threshold, and transmits a notice of timeout to an information processing apparatus serving as a transmission source of the discriminated packet.

If the relay device 10 increments the priority data and transmits the packet containing the priority data with the greatest value as described above, the relay device 10 may easily recognize the accumulated wait time taken for each of the packets to wait for arbitration. Incidentally, when updating the value of the priority data, the relay device 10 may update the priority data by using an arbitrary formula, instead of incrementing or decrementing the priority data.

(2) Configuration Example of a Packet

Each of the packets as described above contains the priority data in the header; however, the embodiments are not limited thereto. The priority data may be contained in an arbitrary position other than the header.

(3) Initial Value of the Priority Data

All of the information processing apparatuses 2 to 6 transmit packets, in each of which the same value is stored as the priority data of the packet to be transmitted; however, the embodiments are not limited thereto. For example, each of the information processing apparatuses 2 to 6 may preferentially transmit a packet that is to be transmitted in priority to other packets, by storing the priority data with a smaller value in advance.

Incidentally, the priority data in the packet may be determined by an operating system (OS) that runs on each of the information processing apparatuses 2 to 6, or may be set arbitrarily by a function or a device in a lower layer than the OS. Furthermore, each of the information processing apparatuses 2 to 6 may set the priority data with a value corresponding to the degree of congestion in the communication system 1.

(4) Relay Device

The relay devices 7, 8, and 10 as described above may be employed for a connection to a devices such as a peripheral components interconnect bus express (PCIe), in addition to a communication using a transmission control protocol/Internet protocol (TCP/IP). Namely, the relay devices 7, 8, and 10 may be applied to a system that performs communications by using an arbitrary method as long as the priority data may be stored in the packet.

According to an aspect of an embodiment, there is provided a relay device that receives pieces of data. The relay device updates a value indicating an accumulated wait time for arbitration contained in each of the received pieces of the data, according to an elapsed time. The relay device compares the values indicating the accumulated wait times for arbitration contained in the respective pieces of the data, and selects a piece of data to be transmitted according to a result of the comparison. The relay device transmits the selected piece of the data to other device.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A relay device comprising:
a plurality of receiving units each being configured to receive a piece of data containing a value indicating an accumulated wait time for arbitration;
an updating unit that updates the value indicating the accumulated wait time for arbitration contained in each of pieces of the data received by the receiving units, according to an elapsed time;
a selecting unit that selects a piece of data to be transmitted, according to a result of comparison of the values indicating accumulated wait times for arbitration contained in the respective pieces of the data; and
a transmitting unit that transmits the piece of the data selected by the selecting unit to other device.

2. The relay device according to claim 1, wherein
the updating unit increments the value indicating the accumulated wait time for arbitration contained in each of the pieces of the data according to an elapsed time,
the selecting unit selects, as a piece of data to be transmitted, the piece of the data containing a greatest value as the value indicating the accumulated wait time for arbitration.

3. The relay device according to claim 2, wherein when a plurality of pieces of data contains the greatest values as the values indicating the accumulated wait times for arbitrations, the selecting unit selects, as a piece of data to be transmitted, one of the plurality of pieces of the data containing the greatest values by round-robin method.

4. The relay device according to claim 2, further comprising:
a determining unit that determines whether the value indicating the accumulated wait time for arbitration contained in each of the plurality of pieces of the data received by the receiving units is equal to or greater than a predetermined threshold; and
a notifying unit that, when the determining unit determines that the value indicating the accumulated wait time for arbitration contained in any of the pieces of the data is equal to or greater than the predetermined threshold, sends a notice of timeout to a transmission source of the piece of the data containing the accumulated wait time being equal to or greater than the predetermined threshold.

5. The relay device according to claim 1, wherein
the updating unit decrements the value indicating the accumulated wait time for arbitration contained in each of the plurality of pieces of the data according to an elapsed time, and
the selecting unit selects, as a piece of data to be transmitted, the piece of data containing a smallest value as the value indicating the accumulated wait time for arbitration.

6. The relay device according to claim 5, wherein when a plurality of pieces of data contains the smallest values as the values indicating the accumulated wait times for arbitrations, the selecting unit selects, as a piece of data to be transmitted, one of the plurality of pieces of the data containing the smallest values by round-robin method.

7. The relay device according to claim 5, further comprising:
a determining unit that determines whether the value indicating the accumulated wait time for arbitration contained in each of the plurality of pieces of the data received by the receiving units is equal to or smaller than a predetermined threshold; and
a notifying unit that, when the determining unit determines that the value indicating the accumulated wait time for arbitration contained in any of the pieces of the data is equal to or smaller than the predetermined threshold, sends a notice of timeout to a transmission source of the piece of the data containing the accumulated wait time being equal to or smaller than the predetermined threshold.

8. A relay method implemented by a relay device that includes a plurality of receiving devices configured to receive pieces of data, and that relays the pieces of the data received by the receiving devices, the relay method comprising:
updating a value indicating an accumulated wait time for arbitration contained in each of the pieces of the data received by the receiving devices;
selecting a piece of data to be transmitted, according to a result of comparison of the values indicating accumulated wait times for arbitration contained in the respective pieces of the data; and
transmitting the piece of the data selected at the selecting to other device.
